(19) United States
(12) Patent Application Publication
(10) Pub. No.: US 2019/0245396 A1
(43) Pub. Date: Aug. 8, 2019

(54) ROTOR CORE MANUFACTURING METHOD AND ROTOR CORE

(71) Applicant: AISIN AW CO., LTD., Anjo-shi, Aichi-ken (JP)

(72) Inventors: Masayuki IKEMOTO, Anjo (JP); Hideharu USHIDA, Anjo (JP); Takehiro ANAI, Anjo (JP)

(73) Assignee: AISIN AW CO., LTD., Anjo-shi, Aichi-ken (JP)

(21) Appl. No.: 16/341,946

(22) PCT Filed: Dec. 25, 2017
(86) PCT No.: PCT/JP2017/046439

§ 371 Date: Apr. 15, 2019

(30) Foreign Application Priority Data
Dec. 26, 2016 (JP) 2016-251494

(51) Int. Cl. H02K 1/27; H02K 15/03

(52) U.S. Cl. CPC H02K 1/276; H02K 15/03

(57) ABSTRACT

A method for manufacturing a rotor core for a rotary electric machine, the method includes: stacking a plurality of electromagnetic steel plates having holes so that the holes are continuous with each other to form a through hole; and welding an inner surface of the through hole along a stacking direction while the through hole is filled with inert gas.

### BACKGROUND

The present disclosure relates to a rotor core for a rotary electric machine and a method for manufacturing the same.

A rotor core for a rotary electric machine may be structured by a plurality of electromagnetic steel plates stacked in an axial direction. Japanese Patent Application Publication No. 2002-209345 (JP 2002-209345 A) discloses a method of manufacturing a rotor core of this form in which outer peripheral surfaces of a plurality of stacked electromagnetic steel plates are welded by laser welding to integrate the electromagnetic steel plates with each other. It is possible to simplify the manufacturing process and shorten manufacturing time by using laser welding.

However, generation of plume etc. may typically be a problem in laser welding. In this respect, Japanese Patent Application Publication No. 2012-179615 (JP 2012-179615 A) discloses a method of performing laser welding while supplying inert gas to a welding portion and exhausting the inert gas to suppress generation of plume and oxidization of a processed portion. However, in this case, productivity decreases since there is a need to weld stacked electromagnetic steel plates disposed in a dedicated chamber.

### SUMMARY

An exemplary aspect of the disclosure improves manufacturing of a rotor core by integrally welding stacked electromagnetic steel plates.

A method for manufacturing a rotor core according to the present disclosure is a method for manufacturing a rotor core for a rotary electric machine, including: stacking a plurality of electromagnetic steel plates having holes so that the holes are continuous with each other to form a through hole; and welding an inner surface of the through hole along a stacking direction while the through hole is filled with inert gas.

With this configuration, welding is performed while the through hole formed in the rotor core is filled with inert gas. Thus, in the welding, there is no need to dispose the electromagnetic steel plates inside a dedicated chamber. It is therefore possible to improve the productivity when manufacturing a rotor core by integrally welding stacked electromagnetic steel plates.

Further features and advantages of the technique according to the disclosure will become apparent from the following descriptions of the embodiments which are exemplary and non-limiting and which are given with reference to the accompanying drawings.

### BRIEF DESCRIPTION OF THE DRAWINGS

FIG. 1 is a perspective view of a rotor according to an embodiment.

FIG. 2 is an enlarged plan view of the rotor.

FIG. 3 is a schematic diagram of a stacking step.

FIG. 4 is a schematic diagram of a phase of a welding step (gas filling step).

FIG. 5 is a schematic diagram of a phase of the welding step (first laser irradiation step).

FIG. 6 is a schematic diagram of a distribution of welding strength after the first laser irradiation step is completed.

FIG. 7 is a schematic diagram of a phase of the welding step (second laser irradiation step).

FIG. 8 is a schematic diagram of a distribution of welding strength after the second laser irradiation step is completed.

### DETAILED DESCRIPTION OF EMBODIMENTS

An embodiment of a rotor with a rotor core will be described with reference to the drawings. A rotor 100 of the present embodiment is included in a rotary electric machine serving as a driving force source of wheels in a hybrid vehicle or an electric vehicle etc. The rotary electric machine has a stator fixed to a non-rotary member and the rotor 100 that is adjacent to the stator in a radial direction and that is rotatably supported. The rotor 100 of the present embodiment is formed as an inner rotor disposed radially inward of the stator.

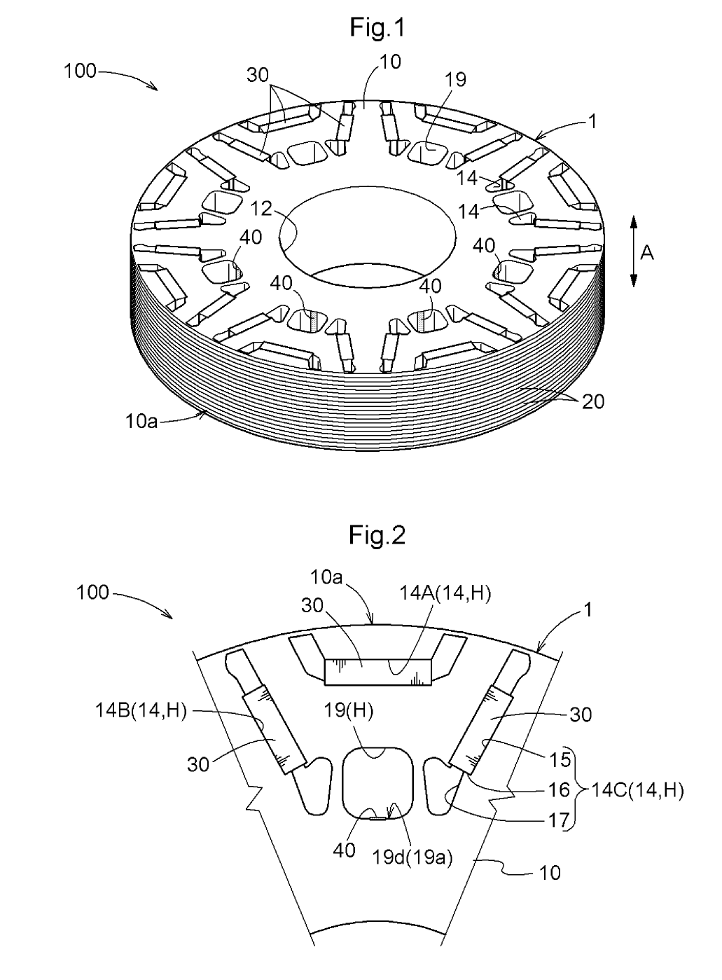

As shown in FIG. 1, the rotor 100 has a rotor core 1 and permanent magnets 30 that are embedded in the rotor core 1. That is, the rotor 100 of the present embodiment is formed as a permanent magnet embedded-type rotor.

The rotor core 1 is formed by a plurality of electromagnetic steel plates 20 that are stacked in an axial direction A. The electromagnetic steel plates 20 have an annular disc shape. The electromagnetic steel plates 20 stacked in the axial direction A are integrated by laser welding.

The rotor core 1 has a core body 10 composed of the integrated electromagnetic steel plates 20. The core body 10 has a central hole 12 in a radial inner side. The core body 10 has a plurality of magnet insertion holes 14 and a plurality of magnetic barrier holes 19 distributed in a circumferential direction. The rotor core 1 (core body 10) is fixed to a rotor shaft inserted in the central hole 12. An outer peripheral surface of the rotor core 1 (core body 10) is a stator-facing surface 10a facing the stator.

Each of the magnet insertion holes 14 and the magnetic barrier holes 19 extends through in the axial direction A. At least either the magnet insertion holes 14 or the magnetic barrier holes 19 function as “through holes H”. In the present embodiment, among the magnet insertion holes 14 and the magnetic barrier holes 19, the magnetic barrier holes 19 function as the through holes H. Each of the magnet insertion holes 14 is a hole in which the permanent magnet 30 is inserted. In the present embodiment, three magnet insertion holes 14 are provided for every magnetic pole, as shown in FIG. 2. A first magnet insertion hole 14A is formed in a radial outer side portion of the core body 10 generally along the circumferential direction. A second magnet insertion hole 14B and a third magnet insertion hole 14C are arranged on the opposite sides of the first magnet insertion hole 14A in the circumferential direction and are formed generally along the radial direction.

Each magnet insertion hole 14 has a magnet arrangement portion 15 in which the permanent magnet 30 is arranged and a pair of magnetic barrier portions 17 provided on both sides of the magnet arrangement portion 15 in a longitudinal direction. The magnetic barrier portions 17 function as a magnetic resistance (flux barrier) with respect to magnetic flux that flows through the rotor core 1 (core body 10). Locking portions 16 locked to end surfaces of each permanent magnet 30 on both sides in the longitudinal direction are each provided in a boundary portion between the magnet arrangement portion 15 and the magnetic barrier portion 17. The permanent magnet 30 is positioned in the magnet arrangement portion 15 by the locking portions 16. In this state, the permanent magnet 30 is embedded in the rotor core 1 so as to extend through the rotor core 1 in the axial direction A.

Each magnetic barrier hole 19 is formed between end portions radially inward of the second magnet insertion hole 14B and the third magnet insertion hole 14C (radially inward of the magnetic barrier portions 17) in the circumferential direction. Similar to the magnetic barrier portions 17 of the magnet insertion hole 14, the magnetic barrier hole 19 also functions as a magnetic resistance (flux barrier) with respect to magnetic flux flowing through the rotor core 1 (core body 10). The magnetic barrier hole 19 restricts the flow of magnetic flux in the rotor core 1 (core body 10).

A manufacturing method of the rotor core 1 for the rotary electric machine of the present embodiment includes a stacking step and a welding step.

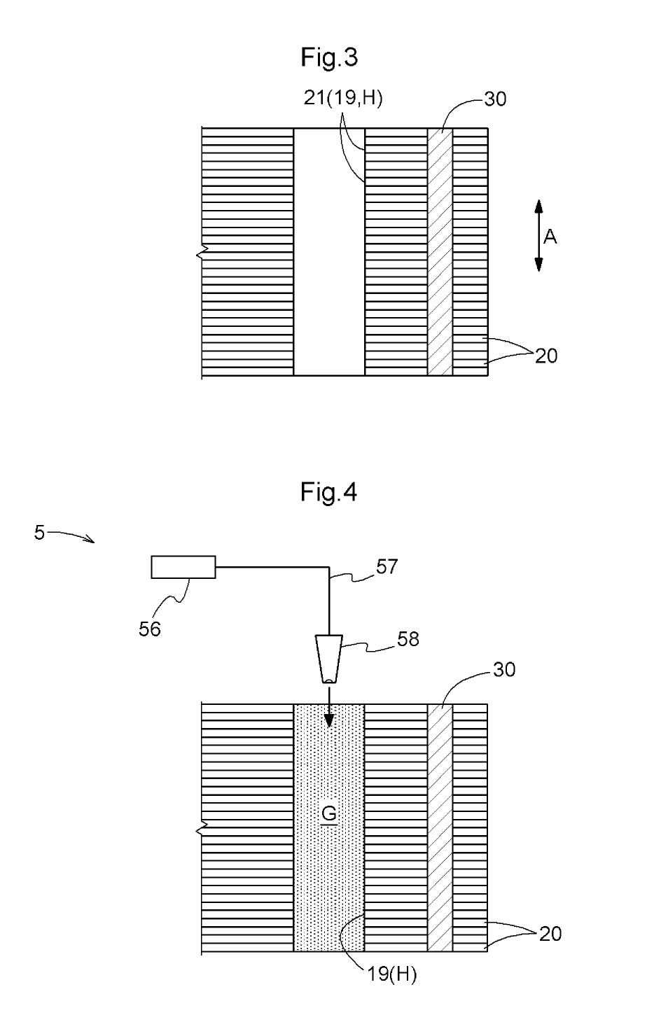

In the stacking step, a plurality of the electromagnetic steel plates 20 having hole portions 21 (holes) are stacked so that the hole portions 21 are continuous with each other in the axial direction A to form the through hole H (magnetic barrier hole 19), as shown in FIG. 3. At this time, the magnet insertion hole 14 is also formed so as to extend through in the axial direction A. In the present embodiment, the electromagnetic steel plates 20 are stacked along an up-down direction in the stacking step. In the present embodiment, the axial direction A can be regarded as a “stacking direction” of the electromagnetic steel plates 20.

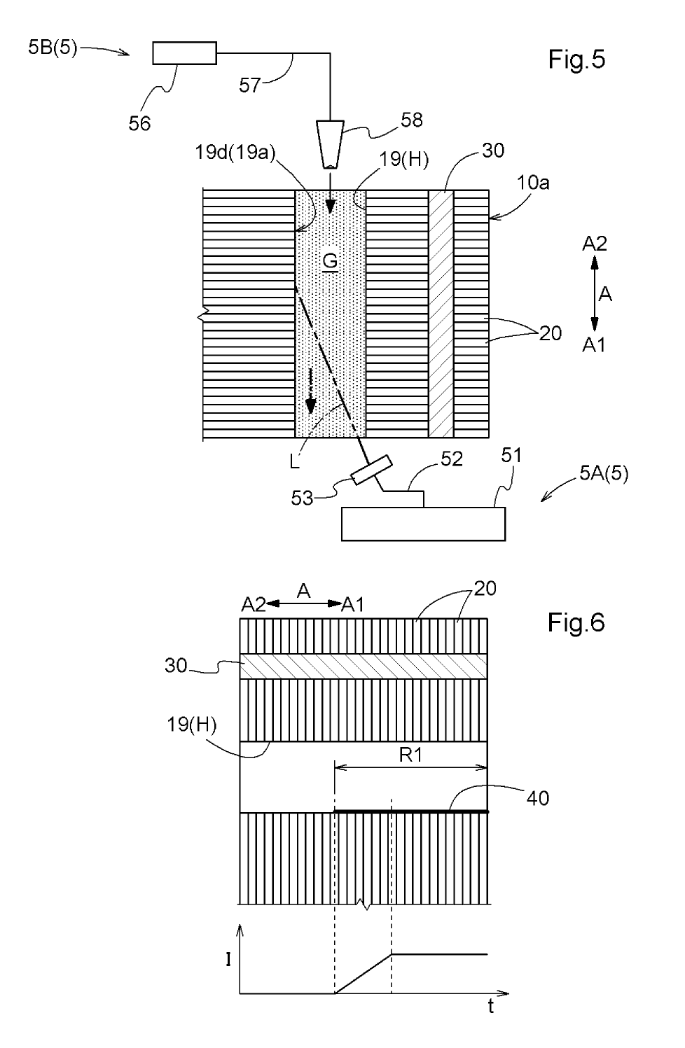

The welding step may be performed using a laser beam welding device 5 (see FIG. 5 etc.). The laser beam welding device 5 has a laser beam irradiation mechanism 5A for irradiating a laser beam L. This laser beam irradiation mechanism 5A includes a laser oscillator 51, an optical path 52, and a condensing lens 53. The laser oscillator 51 oscillates a laser beam L such as a CO₂ laser or a YAG laser. The laser beam L from the laser oscillator 51 goes through the optical path 52 formed of a fixed optical system or optical fiber etc. and is condensed by the condensing lens 53. The laser beam L is then irradiated to a stacked body of the electromagnetic steel plates 20 that is a workpiece (specifically, an inner surface 19a of the magnetic barrier hole 19 serving as the through hole H). In the present embodiment, the laser beam welding device 5 is configured to move the irradiated laser beam L (to move a focal point of the laser beam L).

The laser beam welding device 5 of the present embodiment also has a gas supply mechanism 5B for supplying shielding gas. The gas supply mechanism 5B includes a gas supply source 56, a pipeline 57 connected to the gas supply source 56, and a gas nozzle 58 connected to an end portion of the pipeline 57. The gas supply source 56 is a gas cylinder for example, and supplies inert gas G such as nitrogen gas, argon gas, or helium gas. The inert gas G from the gas supply source 56 goes through the pipeline 57 to be injected from the gas nozzle 58. The gas nozzle 58 is provided so as to face the stacked body (specifically, the magnetic barrier hole 19 serving as the through hole H) of the electromagnetic steel plates 20 that is the workpiece.

The laser beam irradiation mechanism 5A and the gas supply mechanism 5B are arranged on the opposite sides in the stacking direction (axial direction A), with respect to the stacked body of the electromagnetic steel plates 20 that is the workpiece. Particularly in the present embodiment, the gas supply mechanism 5B is disposed above the stacked body of the electromagnetic steel plates 20 and the laser beam irradiation mechanism 5A is disposed below the stacked body of the electromagnetic steel plates 20.

In the welding step, an inner surface of the through hole H is welded along the stacking direction (axial direction A) while the through hole H (magnetic barrier hole 19) is filled with inert gas G, by using such a laser beam welding device 5. The welding step of the present embodiment includes a gas filling step and a laser irradiation step. The laser irradiation step includes a first laser irradiation step and a second laser irradiation step.

In the gas filling step, inert gas G is injected from the gas nozzle 58 so that the through hole H (magnetic barrier hole 19) is filled with inert gas G, as shown in FIG. 4. At this time, in the through hole H, it is possible to suppress variation in concentration of inert gas G among the positions, since the through hole H (magnetic barrier hole 19) formed in the stacked body of the electromagnetic steel plates 20 is a relatively narrow hole portion. Additionally, it is possible to keep the amount of supplied inert gas G small, compared to a configuration in which inert gas G is supplied to the entire space that houses the stacked body of the electromagnetic steel plates 20.

In the present embodiment, inert gas G is continuously injected from the gas nozzle 58, even after the gas filling step is completed (even after the through hole H is filled with inert gas G). The rate of gas flow after the gas filling step is completed may be the same as the rate of gas flow during the gas filling step or may be less than the rate of gas flow during the gas filling step.

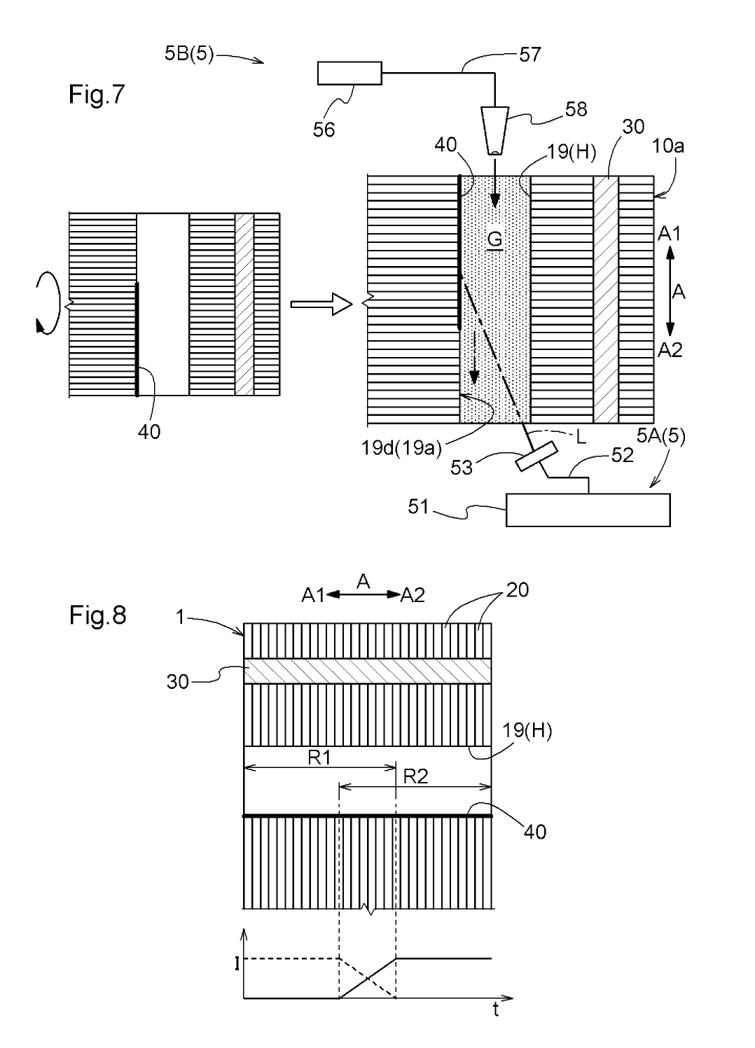

As shown in FIGS. 5 and 7, in the laser irradiation step (first laser irradiation step and second laser irradiation step), the inner surface 19a of the through hole H (magnetic barrier hole 19) is laser-welded along the stacking direction (axial direction A) while inert gas G is passed through the through hole H. At this time, injection of inert gas G into the through hole H is performed from one side and laser irradiation into the through hole H is performed from the other side in the stacking direction (axial direction A). Specifically, in the laser irradiation step, laser beam L is irradiated from below while inert gas G is injected from above to flow downward so as to weld the inner surface 19a of the through hole H (magnetic barrier hole 19a).

In the present embodiment, in the laser irradiation step, a distal side inner surface 19d of the through hole H is laser-welded. The distal side inner surface 19d is a part of the inner surface 19a on a side distant from the surface facing the stator (stator-facing surface 10a).

As shown in FIG. 5, in the first laser irradiation step that is the former half step of the laser irradiation step, a first laser irradiation is performed from a first side in a stacking direction (in the present example, the first axial side A1) that is one side of the electromagnetic steel plates 20 in the stacking direction (in the present example, the axial direction A). In the first laser irradiation step, the first laser irradiation is performed from the first side in the stacking direction (first axial side A1) to a first region R1 positioned on the first side in the stacking direction (first axial side A1) in the through hole H. At this time, the irradiated laser beam L is moved from a central part side of the through hole H to a lower side that is an end portion side of the first side in the stacking direction (first axial side A1) so as to perform laser welding along the stacking direction (axial direction A).

When the first laser irradiation step is completed, a welding portion 40 is formed in the first region R1 in the through hole H, as shown in FIG. 6. The welding portion 40 does not have the same welding strength throughout the entire region. The welding strength of the welding portion 40 differs depending on a position along the stacking direction (axial direction A). This is related to the output characteristic of the laser beam L. That is, the laser beam L of the present embodiment has an output characteristic in which laser strength (I) gradually increases over time (t) when output is started and after a prescribed period of time passes, the laser strength (I) becomes constant. If the irradiated laser beam L is moved at a constant speed, the relationship between the position along the stacking direction (axial direction A) and the welding strength is defined based on the relationship between the elapsed time (t) and the laser strength (I). In the present example, a part of the first region R1 on the central part side of the through hole H has a lower welding strength than other parts.

After the first laser irradiation step is completed, the stacked body of the electromagnetic steel plates 20 is turned over in the stacking direction (axial direction A). Due to this reversing operation, the welding portion 40 in the first region R1 on the first side in the stacking direction (first axial side A1), which was generated by the first laser irradiation step, is disposed in an upper part. In a lower part, the second region R2 is disposed. The second region R2 is positioned on a second side in the stacking direction (in the present example, the second axial side A2) which is the other side of the electromagnetic steel plates 20 in the stacking direction (in the present example, the axial direction A). Note that the first region R1 and the second region R2 overlap with each other on the central part side of the through hole H (see FIG. 8).

In the second laser irradiation step that is the latter half step of the laser irradiation step, the second laser irradiation is performed from the second side in the stacking direction (in the present example, second axial side A2). In the second laser irradiation step, the second laser irradiation is performed from the second side in the stacking direction (second axial side A2) to the second region R2 positioned on the second side in the stacking direction (second axial side A2) of the through hole H. At this time, the irradiated laser beam L is moved from the central part side of the through hole H to a lower side that is the end portion side of the second side in the stacking direction (second axial side A2) so as to perform laser welding along the stacking direction (axial direction A).

When the second laser irradiation step is completed, the welding portion 40 is formed in the second region R2 in the through hole H, as shown in FIG. 8. Similar to the welding portion 40 in the first region R1, a part of the welding portion 40 in the second region R2 on the central part side in the through hole H has a lower welding strength than other parts. The overlapping parts of the welding portions 40 of the first region R1 and the second region R2 on the central part side in the through hole H individually do not have sufficient welding strength, but supplement each other for the shortage of the welding strength. In this part, the welding strength according to the sum of the laser strength (I) of the first region R1 indicated by a broken line and the laser strength (I) of the second region R2 indicated by a solid line in FIG. 8 are ensured. As a result, the welding portion 40 having a generally uniform and sufficient welding strength is formed throughout the entire region in the stacking direction (axial direction A).

In the laser irradiation step (first laser irradiation step and second laser irradiation step), laser welding is performed while the through hole H is filled with inert gas G. Thus, in the presence of inert gas G, blow holes and spatter etc. are less likely to be generated. Since the through hole H is relatively narrow, in the through hole H, it is possible to suppress variation in concentration of inert gas G among the positions, thereby suppressing generation of blow holes and spatter etc. in this way as well.

Laser welding is performed while causing inert gas H to flow through the through hole H. Therefore, even if spatter etc. is generated, it is possible to suppress the generated spatter etc. from being attached to the through hole H with injection pressure of inert gas G. Moreover, since the through hole H is relatively narrow, the injection pressure is easily maintained without diffusing inert gas G in the through hole H. It is thus possible to make the generated spatter etc. flow so as to effectively suppress the generated spatter etc. from being attached to the rotor core 1.

The rotor core 1 manufactured in this way includes the following components. That is, the rotor core 1 is formed of the electromagnetic steel plates 20 that are stacked in the axial direction A and has the magnetic barrier hole 19 serving as the through hole H that extends through the electromagnetic steel plates 20 in the axial direction A. In the rotor core 1, the inner surface 19a of the through hole H (magnetic barrier hole 19) has the welding portion 40 extending along the axial direction A. Only a small number of blow holes or spatter is included in the welding portion 40, and thus it is possible to obtain the rotor core 1 that has the sufficient welding strength and that has little attachment of foreign matter.

The welding portion 40 is formed on the distal side inner surface 19d that is a part of the inner surface 19a of the through hole H (magnetic barrier hole 19d) on the side distant from the surface facing the stator (stator-facing surface 10a). Thus, compared to the case in which the welding portion 40 is formed on a part of the inner surface 19a of the through hole H (magnetic barrier hole 19) on the side near the stator-facing surface 10a, it is possible to suppress the effect on the magnetic flux flowing through the rotor core 1 (core body 10).

### Other Embodiments

(1) In the above embodiment, the configuration in which the electromagnetic steel plates 20 are stacked along the up-down direction in the stacking step is described as an example. However, the configuration is not limited to this. The electromagnetic steel plates 20 may be stacked along a left-right direction.

(2) In the above embodiment, the configuration in which the through hole H is supplied with inert gas G while both ends of the through hole H are open in the gas filling step is described. However, the configuration is not limited to this. For example, inert gas G may be supplied while at least one end of the through hole H is covered with a lid. When such a lid is disposed, the lid may be provided with a vent for supplying or discharging air so that inert gas G is able to pass through. On a supplying side, the gas nozzle 58 may be connected to the vent of the lid.

(3) In the above embodiment, the configuration in which laser welding is performed while inert gas G is passed through the through hole H in the laser irradiation step is described as an example. However, the configuration is not limited to this. For example, laser welding may be performed while the through hole H is just filled with inert gas G, without causing inert gas G to pass through the through hole H.

(4) In the above embodiment, the configuration in which laser welding is performed while inert gas G is passed through the through hole H from above in the laser irradiation step is described as an example. However, the configuration is not limited to this. For example, laser welding may be performed while inert gas G is passed through from below.

(5) In the above embodiment, the configuration in which injection of inert gas G into the through hole H is performed from one side and laser irradiation into the through hole H is performed from the other side in the stacking direction (axial direction A) in the laser irradiation step is described as an example. However, the configuration is not limited to this. For example, injection of inert gas G and laser irradiation into the through hole H may be performed from the same side in the stacking direction (axial direction A).

(6) In the above embodiment, the configuration in which laser irradiation is performed in the laser irradiation step in two steps, namely, the first laser irradiation to the first region R1 and the second laser irradiation to the second region R2, is described as an example. However, the configuration is not limited to this. For example, laser irradiation over the entire region in the stacking direction (axial direction A) may be performed once.

(7) In the above embodiment, the configuration in which the first region R1 and the second region R2 are disposed so as to overlap is described as an example. Here, the first laser irradiation is performed in the first region R1 and the second laser irradiation is performed in the second region R2 in the laser irradiation step. However, the configuration is not limited to this. For example, the first region R1 and the second region R2 may be disposed so as not to overlap with each other.

(8) In the above embodiment, the configuration in which laser welding is performed on the distal side inner surface 19d of the inner surface 19a of the through hole H (magnetic barrier hole 19) on the side distant from the stator-facing surface 10a, in the laser irradiation step is described as an example. However, the configuration is not limited to this. For example, laser welding may be performed on a part of the inner surface 19a of the through hole H (magnetic barrier hole 19), on the side near the stator-facing surface 10a (proximal inner surface).

(9) In the above embodiment, the configuration in which laser welding is performed on the inner surface 19a of the magnetic barrier hole 19 in the laser irradiation step is described as an example. However, the configuration is not limited to this. For example, laser welding may be performed on an inner surface of the magnet insertion hole 14 (magnetic barrier portion 17, for example). In this case, the magnet insertion hole 14 functions as the “through hole H”.

(10) In the above embodiment, the configuration in which laser welding is performed in a single through hole H along the entire stacking direction (axial direction A) in the laser irradiation step is described as an example. However, the configuration is not limited to this. For example, the position along the stacking direction (axial direction A) at which laser welding is performed may be made different for several through holes H, and the welding portion 40 may be divided among the through holes H to form the welding portion 40 along the entire stacking direction (axial direction A) as a whole.

(11) In the above embodiment, the configuration in which the rotor core 1 is a rotor core for an inner rotor is described as an example. However, the configuration is not limited to this. The technique of the present disclosure may be similarly applied to a rotor core of an outer rotor.

(12) In the above embodiment, the rotor core 1 that is provided in a rotary electric machine serving as a driving force source for wheels of a vehicle is described as an example. However, the rotor core 1 is not limited to a rotor core for driving a vehicle. The technique of the present disclosure may be similarly applied to a rotor core provided in rotary electric machines for all purposes.

(13) The structures disclosed in the above embodiments (including the above embodiment and the other embodiments; the same applies hereinafter) may be applied combined with the structures disclosed in the other embodiments as long as no inconsistency arises. Regarding other structures as well, the embodiments disclosed in the specification are shown by way of example in all respects, and various modifications may be made as appropriate without departing from the spirit and scope of the disclosure.

### Summary of Embodiments

Based on the above description, a method for manufacturing a rotor core according to the present disclosure preferably includes the following configurations.

The method for manufacturing the rotor core (1) for a rotary electric machine includes:

the stacking step of stacking the electromagnetic steel plates (20) having the hole portions (21) so that the hole portions (21) are continuous with each other to form the through hole (H); and

the welding step of welding the inner surface of the through hole (H) along the stacking direction (A) while the through hole (H) is filled with inert gas (G).

With this configuration, welding is performed while the through hole (H) formed in the rotor core (1) is filled with inert gas (G). Thus, in the welding step, there is no need to dispose the electromagnetic steel plates (20) inside a dedicated chamber. It is therefore possible to improve the productivity for manufacturing the rotor core (1) by integrally welding stacked electromagnetic steel plates (20).

As one aspect,

the through hole (H) is preferably at least one of the magnet insertion hole (14) in which the permanent magnet (30) is inserted and the magnetic barrier hole (19) that restricts the flow of magnetic flux.

With this configuration, it is possible to use at least one of the magnet insertion hole (14) and the magnetic barrier hole (19) that are provided in a permanent magnet embedded-type rotor to improve productivity.

As one aspect,

in the welding step, welding is preferably performed on a part of the inner surface of the through hole (H) on the side distant from the surface (10a) facing the stator.

With this configuration, it is possible to suppress the effect on magnetic flux flowing through the rotor core (1), compared to the case in which welding is performed on a part of the inner surface of the through hole (H) on the side near the surface (10a) facing the stator.

As one aspect,

in the welding step, welding is preferably performed while inert gas (G) is constantly supplied to the through hole (H) and inert gas (G) is constantly discharged from the through hole (H).

Even if laser welding is performed while the dedicated chamber is supplied with inert gas (G), blow holes may be generated in the welding portion due to the variation in concentration of inert gas (G) among the positions. If the blow holes are generated in the welding portion, the welding strength decreases, which is not favorable. There is also a case in which spatter or fumes are generated due to high-energy laser irradiation and remain near the welding portion. If such foreign matter remains, the foreign matter may fall during use of the rotary electric machine incorporating the rotor core (1) and lead to deterioration in performance of the rotary electric machine, which is not favorable.

In this respect, in the technique of the present disclosure, welding is performed while the relatively narrow through hole (H) formed in the rotor core (1) is filled with inert gas (G). Thus, in the through hole (H), it is possible to suppress variation in concentration of inert gas (G) among the positions. In the first place, blow holes or spatter etc. is hardly generated. With the above configuration, even if spatter etc. is generated, it is possible to cause the generated spatter etc. to flow with injection pressure of inert gas (G) so as to suppress the generated spatter etc. from being attached to the rotor core (1).

As one aspect,

in the welding step, welding is preferably performed while inert gas (G) is constantly supplied from the first side in the stacking direction (A1) which is one side of the through hole (H) in the stacking direction (A) and inert gas (G) is constantly discharged from the second side in the stacking direction (A2) which is the other side of the through hole (H) in the other stacking direction (A).

With this configuration, it is possible to form a smooth flow of inert gas (G) from the first side in the stacking direction (A1) towards the second side in the stacking direction (A2) in the through hole (H). Thus, even if spatter etc. is generated, it is possible to further effectively suppress the generated spatter etc. from being attached to the rotor core (1).

As one aspect,

the electromagnetic steel plates (20) is preferably stacked along the up-down direction in the stacking step, and

welding is preferably performed while inert gas (G) is constantly supplied from above in the welding step.

With this configuration, it is possible to effectively suppress the generated spatter etc. from being attached to the rotor core (1) by using the action of gravity in addition to using injection pressure of inert gas (G).

As one aspect,

the welding step is preferably performed by laser welding, and in the welding step, inert gas (G) may be injected into the through hole (H) from one side and laser irradiation into the through hole (H) is preferably performed from the other side in the stacking direction (A).

With this configuration, it is possible to appropriately dispose the gas supply mechanism for supplying inert gas (G) and the laser beam irradiation mechanism for irradiating the laser beam (L) without mutual interference. Thus, it is possible to appropriately implement the configuration in which laser welding is performed while inert gas (G) is passed through the through hole (H).

As one aspect,

the welding step is preferably performed by laser welding, and in the welding step, the first laser irradiation is preferably performed from the first side in the stacking direction (A1) to the first region (R1) that is positioned on the first side in the stacking direction (A1) which is one side of the through hole (H) in the stacking direction (A). Additionally, in the welding step, the second laser irradiation is preferably performed from the second side in the stacking direction (A2) to the second region (R2) that is positioned on the second side in the stacking direction (A2) which is the other side of the through hole (H) in the stacking direction (A) and that overlaps with the first region (R1).

With this configuration, laser irradiation is performed in two steps from different sides in the axial direction (A). Thus, it is possible to appropriately perform welding throughout the entire region of the through hole (H) along the axial direction (A), even in the through hole (H) that is relatively narrow. Since the first region (R1) and the second region (R2) overlap, it is possible to ensure a sufficient welding strength throughout the entire region in the stacking direction (A), even if the output characteristic of the laser beam (L) is not constant.

The rotor core according to the present disclosure preferably has the following configurations.

In the rotor core (1) for the rotary electric machine,

the rotor core (1) is formed of the electromagnetic steel plates (20) stacked in the axial direction (A),

the rotor core (1) has, as the through hole (H) that extends through the electromagnetic steel plates (20) in the axial direction (A), at least one of the magnet insertion hole (14) in which the permanent magnet (30) is inserted and the magnetic barrier hole (19) that restricts the flow of magnetic flux, and

the rotor core (1) has the welding portion (40) on the inner surface of the through hole (H), the welding portion (40) extending along the axial direction (A).

With this configuration, it is possible to provide the rotor core (1) with high productivity by using at least one of the magnet insertion hole (14) and the magnetic barrier hole (19) and welding the inner surface of the hole along the stacking direction (A) while the hole is filled with inert gas (G).

As one aspect,

the welding portion (40) is preferably provided on the part of the inner surface of the through hole (H) on the side distant from the surface (10a) facing the stator.

With this configuration, it is possible to suppress the effect on magnetic flux flowing through the rotor core (1), compared to the case in which the welding portion (40) is provided on the part of the inner surface of the through hole (H) on the side near the surface (10a) facing the stator.

The method for manufacturing the rotor core and the rotor core according to the present disclosure only need to accomplish at least one of the effects described above.

1-10. (canceled)

11. A method for manufacturing a rotor core for a rotary electric machine, the method comprising:
stacking a plurality of electromagnetic steel plates having holes so that the holes are continuous with each other to form a through hole; and
welding an inner surface of the through hole along a stacking direction while the through hole is filled with inert gas.

12. The method for manufacturing the rotor core according to claim 11, wherein
the through hole is at least one of a magnet insertion hole in which a permanent magnet is inserted and a magnetic barrier hole that restricts a flow of magnetic flux.

13. The method for manufacturing the rotor core according to claim 12, wherein
the welding is performed on a part of the inner surface of the through hole on a side distant from a surface facing a stator.

14. The method for manufacturing the rotor core according to claim 13, wherein
the welding is performed while the inert gas is constantly supplied to the through hole and the inert gas is constantly discharged from the through hole.

15. The method for manufacturing the rotor core according to claim 14, wherein
the welding is performed while the inert gas is constantly supplied from a first side in a stacking direction which is one side of the through hole in the stacking direction and the inert gas is constantly discharged from a second side in the stacking direction which is the other side of the through hole in the stacking direction.

16. The method for manufacturing the rotor core according to claim 15, wherein
the electromagnetic steel plates are stacked along an up-down direction, and the welding is performed while the inert gas is constantly supplied from above.

17. The method for manufacturing the rotor core according to claim 16, wherein
the welding is performed by laser welding, and in the welding, the inert gas is injected into the through hole from one side and laser irradiation is performed from the other side in the stacking direction.

18. The method for manufacturing the rotor core according to claim 17, wherein
the welding is performed by laser welding, and in the welding, a first laser irradiation is performed from the first side in the stacking direction to a first region that is positioned on the first side in the stacking direction which is one side of the through hole in the stacking direction and a second laser irradiation is performed from the second side in the stacking direction to a second region that is positioned on the second side in the stacking direction which is the other side of the through hole in the stacking direction and that partially overlaps with the first region.

19. The method for manufacturing the rotor core according to claim 12, wherein
the welding is performed while the inert gas is constantly supplied to the through hole and the inert gas is constantly discharged from the through hole.

20. The method for manufacturing the rotor core according to claim 11, wherein
the welding is performed on a part of the inner surface of the through hole on a side distant from a surface facing a stator.

21. The method for manufacturing the rotor core according to claim 20, wherein
the welding is performed while the inert gas is constantly supplied to the through hole and the inert gas is constantly discharged from the through hole.

22. The method for manufacturing the rotor core according to claim 11, wherein
the welding is performed while the inert gas is constantly supplied to the through hole and the inert gas is constantly discharged from the through hole.

23. The method for manufacturing the rotor core according to claim 22, wherein
the welding is performed while the inert gas is constantly supplied from a first side in a stacking direction which is one side of the through hole in the stacking direction and the inert gas is constantly discharged from a second side in the stacking direction which is the other side of the through hole in the stacking direction.

24. The method for manufacturing the rotor core according to claim 22, wherein
the electromagnetic steel plates are stacked along an up-down direction, and welding is performed while the inert gas is constantly supplied from above.

25. The method for manufacturing the rotor core according to claim 22, wherein
the welding is performed by laser welding, and in the welding, the inert gas is injected into the through hole from one side and laser irradiation is performed from the other side in the stacking direction.

26. The method for manufacturing the rotor core according to claim 22, wherein
the welding is performed by laser welding, and in the welding, a first laser irradiation is performed from the first side in the stacking direction to a first region that is positioned on the first side in the stacking direction which is one side of the through hole in the stacking direction and a second laser irradiation is performed from the second side in the stacking direction to a second region that is positioned on the second side in the stacking direction which is the other side of the through hole in the stacking direction and that partially overlaps with the first region.

27. A rotor core for a rotary electric machine, the rotor core comprising:
a plurality of electromagnetic steel plates stacked in an axial direction;
as a through hole that extends through the electromagnetic steel plates in the axial direction, at least one of a magnet insertion hole in which a permanent magnet is inserted and a magnetic barrier hole that restricts a flow of magnetic flux; and
a weld on an inner surface of the through hole, the weld extending along the axial direction.

28. The rotor core according to claim 27, wherein
the weld is provided on a part of the inner surface of the through hole on a side distant from a surface facing a stator.
